(19) United States
(12) Patent Application Publication
(10) Pub. No.: US 2005/0051574 A1
(43) Pub. Date: Mar. 10, 2005

(54) Low profile cap for stand-up tube

(75) Inventor: David A. Kesselman, York, PA (US)

Correspondence Address: VENABLE, BAETJER, HOWARD AND CIVILETTI, LLP, P.O. BOX 34385, WASHINGTON, DC, 20043-9998, US

(73) Assignee: Graham Packaging Company, L.P., York, PA (US)

(21) Appl. No.: 10/920,223

(22) Filed: Aug. 18, 2004

Related U.S. Application Data
(60) Provisional application No. 60/496,406, filed on Aug. 20, 2003.

(51) Int. Cl. B67D 5/06

(52) U.S. Cl. 222/107; 222/212; 222/556

(57) ABSTRACT

A low profile, flip-top closure for a container having a top piece, a bottom piece and a joining region. The top piece includes a tubular side wall formed from a first material, a dome covering one end of the tubular side wall of the top piece, and a hinged interconnection formed between the dome and the tubular side wall of the top piece. The bottom piece includes a tubular sidewall formed from a second material. The joining region is formed between the top piece and the bottom piece for joining the top piece to the bottom piece.

### BACKGROUND OF THE INVENTION

The present invention relates generally to squeezable stand-up tubes, and more particularly to a low profile cap for such stand-up tubes.

Various products, such as beverages, are sold to consumers in flexible plastic pouches. For example, U.S. Pat. No. 5,941,642 (Darmstadter), U.S. Pat. No. 5,884,758 (Sigouin et al.), U.S. Pat. No. 5,860,743 (Larkin et al.), U.S. Pat. No. 5,782,344 (Edwards et al.), U.S. Pat. No. 5,350,240 (Billman et al.), U.S. Pat. No. 5,018,646 (Billman et al.), U.S. Pat. No. 4,806,021 (Koudstaal et al.), and U.S. Pat. No. 5,937,617 (Yeager) disclose flexible squeezable pouch containers for fluid or viscous food products. Most of the disclosed pouches require the use of a straw and are free standing on an end thereof in an upright position. All of the disclosed pouches are formed from sheet material which is folded at one end and fused together along the remaining confronting edges.

Another similar type of container typically utilized for packaging personal care or cosmetic products, such as toothpaste and lotions, is a squeezable tube-shaped container having a tubular body with one end heat-sealed along a straight line seam. For instance, U.S. Pat. No. 5,632,951 (Smith), U.S. Pat. No. 3,197,532 (Maass), U.S. Pat. No. 5,908,124 (Klauke et al.), and U.S. Pat. No. 5,213,235 (Miranda) disclose the use of blow molding techniques for forming tube-shaped containers. In addition, the Klauke patent discloses the formation of an integral twist-off closure to eliminate the need for providing a separately manufactured closure. U.S. Pat. No. 4,540,542 (Weiler) discloses a method of making an extrusion blow molded container with an integral removable closure, and U.S. Pat. No. 5,141,136 (Tignor) discloses a squeeze bottle having dual openings. See also WO0238360 (Cargile et al.), which is commonly owned by the assignee of the present invention.

Another method for making a container for packaging a fluid, such as a carbonated beverage, is disclosed by U.S. Pat. No. 4,529,108 (Chlystun) and U.S. Pat. No. 4,619,797 (Chlystun). The method includes blow molding a container body with an open end and a closed end.

### SUMMARY OF THE INVENTION

Although the above referenced, squeezable pouch, tube-shaped and other containers and methods for their manufacture may function satisfactorily for their intended purposes, there is a need for a novel squeezable plastic tube-shaped container which has a cost-effective construction and can be utilized to efficiently package liquid products such as juice and other beverages, viscous products such as yogurt, applesauce, pudding, lotions, and hand soaps, and solid products such as small bead-shaped pieces of candy or the like.

Thus, the present invention is directed to a low profile cap for stand-up tubes of the type disclosed in the aforementioned WO0238360 (Cargile et al.), which is incorporated herein by reference. Alternatively, it is directed to low profile caps for stand-up tubes of the type disclosed herein. That is, the stand-up tube may suitably comprise a container including a top piece, a bottom piece and a joining region. The top piece includes a tubular side wall formed of a first material, a dome covering one end of the tubular side wall of the top piece, and a hinged interconnection formed between the dome and the tubular side wall of the top piece. The bottom piece includes a tubular sidewall formed from a second material. The joining region is formed between the top piece and the bottom piece for joining the top piece to the bottom piece. Preferably, the container can have a closed end providing a dispensing opening and a filling end which is sealed with a seam after filling. The tube-shaped container is capable of being free standing on its dispensing end and can be flexible to permit dispensing of its contents by squeezing of its sidewall. In addition, when the container contents are food or drink, the dispensing end can be protected from contamination and/or unrecognizable tampering before ultimate consumer purchase and use. Finally, the container can be formed of a plastic material, readily recyclable, capable of being manufactured in a cost-effective manner, and adaptable to being made of different colors.

### BRIEF DESCRIPTION OF THE DRAWINGS

The foregoing description of the invention will be apparent from the 2following, more particular description of an embodiment of the invention, as illustrated in the accompanying drawings wherein like reference numbers generally indicate identical, functionally similar, and/or structurally similar elements.

FIG. 1 is a perspective view of a squeezable container according to one embodiment of the present invention;

FIG. 2 is a perspective view of a squeezable container with a dome placed in an outwardly projecting position according to an embodiment of the present invention;

FIG. 3 is a cross-sectional view of the container of FIG. 1, taken along the lines 3--3 therein;

FIG. 4 is a cross-sectional view of the container of FIG. 1 in which the container is being grasped and squeezed and the cap is being removed;

FIG. 5 is an elevational view illustrating the method steps of filling and sealing the open end of the container to form a filled squeezable container;

FIG. 6 is an isometric view of a low-profile flip-top closure according to a presently preferred embodiment of the invention;

FIG. 7 is a front view of the closure shown in FIG. 6;

FIG. 8 is a back view of the closure shown in FIG. 6;

FIG. 9 is an enlarged left side view of the closure shown in FIG. 6;

FIG. 10 is an enlarged right side view of the closure shown in FIG. 6;

FIG. 11 is a top view of the closure shown in FIG. 6;

FIG. 12 is a sectional view of the closure shown in FIG. 6, taken along the lines 12--12 in FIG. 11;

FIG. 13 is a bottom view of the closure shown in FIG. 6; and

FIG. 14 is a sectional view of the closure shown in FIG. 6, taken along the lines 14--14 in FIG. 13.

### DETAILED DESCRIPTION OF THE INVENTION

Embodiments of the invention are discussed in detail below. In describing these embodiments, specific terminology is employed for the sake of clarity. The invention is not intended to be limited to the specific terminology so selected. While specific exemplary embodiments are discussed, it should be understood that this is done for illustration purposes only. One of ordinary skill in the relevant art will recognize that other components and configurations can be used without departing from the true spirit and scope of the invention.

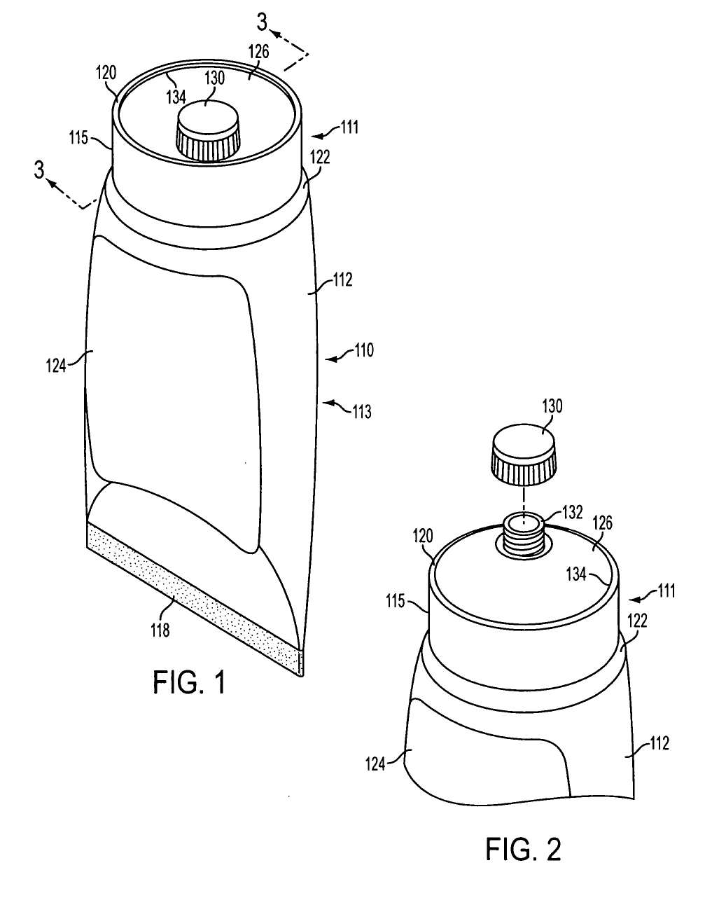

Referring now to the drawings, wherein like reference characters and numerals designate like or corresponding parts throughout each of the several views, there is shown in FIG. 1 a squeezable tube-shaped container 110 embodying the present invention. The container 110 has a two-piece construction with a top piece 111 and a bottom piece 113. Each of the top piece 111 and the bottom piece 113 can be formed of any suitable material including, e.g., plastic material. Suitable plastic material can include a monolayer plastic material, such as LDPE, or a multi-layer plastic material. The top piece 111 can be formed of a material different (i.e., any physical difference including color, material, texture, etc.) from a material of the bottom piece 113. For example, the top piece 111 can have a different color, a different transparency or a different decorative appearance than the bottom piece. The top piece 111 can also be formed from the same material used for the bottom piece 113. Regardless of which materials are used for the top and the bottom pieces, each piece can have an in-mold or other labels applied to its surface while the other piece can be plain. Each of the top piece 111 and the bottom piece 113 can be formed by any suitable method in the art including, but not limited to extrusion, extrusion blow molding, stretch blow molding, injection molding, injection blow molding and compression molding. For example, the top piece 111 can be used by compression molding and/or injection molding and the bottom piece 113 can be formed by blow molding.

Turning first to the structural aspects of the tube-shaped container 110, it has a top piece 111 and a bottom piece 113, which are joined by a joining region 122. The joining region 122 can be formed by any method for joining, including welding, spin-welding, ultra-sonic welding, gluing, etc. The joining region 122 can be circumferential and can be spaced distantly from the standing ring 120. The joining region can prevent ovalization of a standing ring 120 and can reinforce the adjacent sections of the side wall 115 of the top piece 111 and the side wall 112 of the bottom piece 113. The joining region 122 joins the sidewall 115 of the top piece 111 to the sidewall 112 of the bottom piece 113. The sidewall 115 of the top piece 111 can be substantially tubular and can have a circular transverse cross section. The side wall 115 can be flexible and can be bounded by a circular standing ring 120 on which the container 110 can be freely stood with the seam 118 facing upwardly. The sidewall 112 of the bottom piece 113 can be flexible and can be flattened into the seam 118 at its bottom to provide a conventional tube-shaped configuration. The sidewall 112 of the bottom piece 113 can have a label 124 applied during or after the forming stage of the bottom piece.

The bottom piece 113 can be manufactured with an open bottom end which is utilized to fill the container 110 and is thereafter sealed to preferably form a seam 118 as illustrated in FIG. 1. The seam 118 can be of any shape including a planar, straight or curved seam. The sealing can be done by any method for sealing, including heat sealing, compression sealing, and gluing.

As shown in FIG. 2, the top piece 111 has a dome 126 covering one end of the tubular sidewall 115, and a hinged interconnection 134 formed between the dome 126 and the tubular sidewall 115. The dome 126 can be of any geometrical shape, including spherical, cubical, and pyramidal shapes, that creates a convex section in an outwardly projecting position of the dome 126 and can be easily inverted into a corresponding concave section in an inwardly projecting position of the dome 126 by flipping the dome about the hinged interconnection 134 between the standing ring 120 and the dome 126. The dome 126 can be first formed in an outwardly projecting position.

On the dome 126, a neck finish 132 can be formed, wherein the neck finish 132 has an opening via which a product inside the container 110 can be dispensed. The opening of the neck finish 132 extends completely through the neck finish 132 and can be created by various methods. For example, the opening of the neck finish 132 can be created by forming a protrusion that extends out of the neck finish 132 at the time the neck finish 132 is formed and trimming the protrusion subsequently to create the opening. Alternatively, the opening of the neck finish 132 can be created by reaming an opening into the neck finish 132. Still another exemplary method of creating the opening of the neck finish 132 is by using the opening in a blow-molded container as a blow hole or needle insertion point to blow-mold the rest of the neck finish. In any of these embodiments, the opening of the neck finish 132 can be reamed subsequently to form a smooth finish. The neck finish 132 can be any type including a threaded type for twist-closure as shown in FIG. 2, a snap-fit type, a friction-fit type, a push-pull type, etc. The neck finish 132 is suitably fitted with a low profile, flip-top cap 130, as will be described in greater detail herein below.

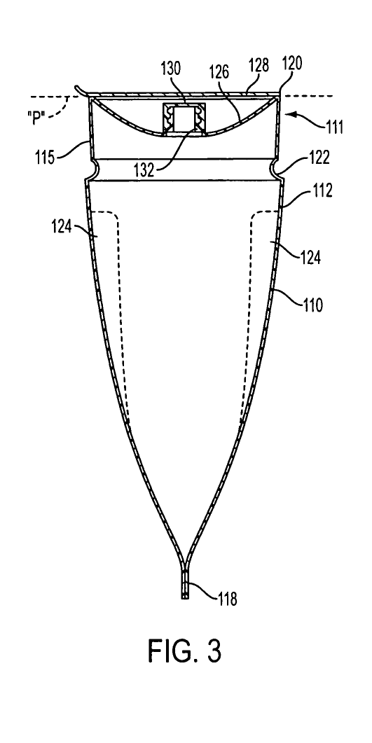

In FIG. 3, the dome 126 is provided in an inwardly projecting position so that the dome 126, the neck finish 132 and the cap 130 lie below a cross-sectional plane “P” extending through the standing ring 120. Thus, the dome 126 has a concave shape and can be said to be in a storage position since the dome 126 and the cap 130 do not interfere with the free standing of the container 110 on the standing ring 120 and permit a tamper indicating covering 128 to be bonded to the standing ring 120 as best illustrated in FIG. 3. The covering 128 can be a foil or other sheet-like covering and can be utilized to prevent contamination or unrecognizable tampering of the neck finish 132 and the cap 130 of the container 110 before its removal by the purchasing consumer. Thus, when the dome 126 is in an inwardly projecting position, the tamper indicating covering 128 can be bonded to the standing ring 20.

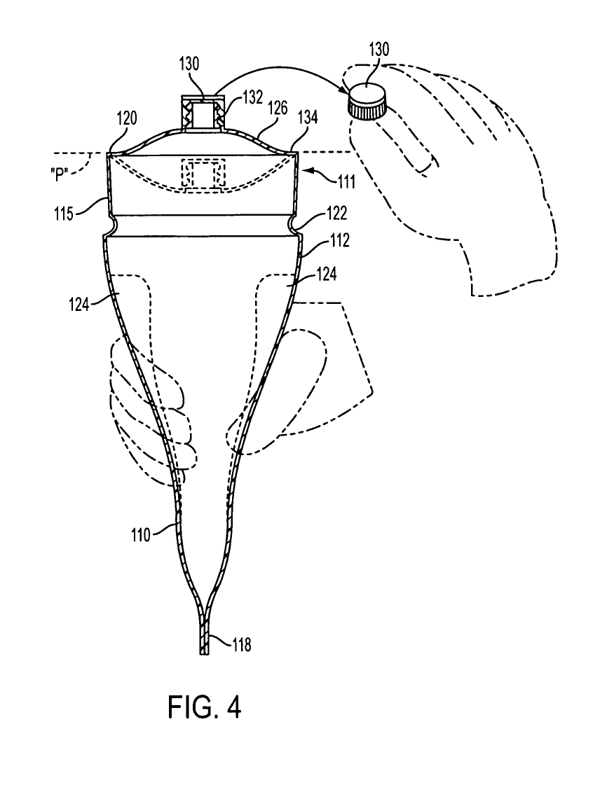

In FIG. 4, the hinged interconnection 134 can be formed from a material that is the same as or is different from a material of the top piece 111 and can be of any type that allows the dome 126 to freely interchange between an outwardly projecting position and an inwardly projecting position, including a live hinge. Thus, in use, when the covering 128 is removed and the flexible sidewall 112 is grasped and squeezed, the dome 126 extends to an outwardly projecting position. This elevates the cap to a readily accessible location for removal by a user to thereby expose an opening of the neck finish 132. Thereafter, a desired quantity of the product inside the container 110 can be dispensed by squeezing the sidewall 112 of the bottom piece 113.

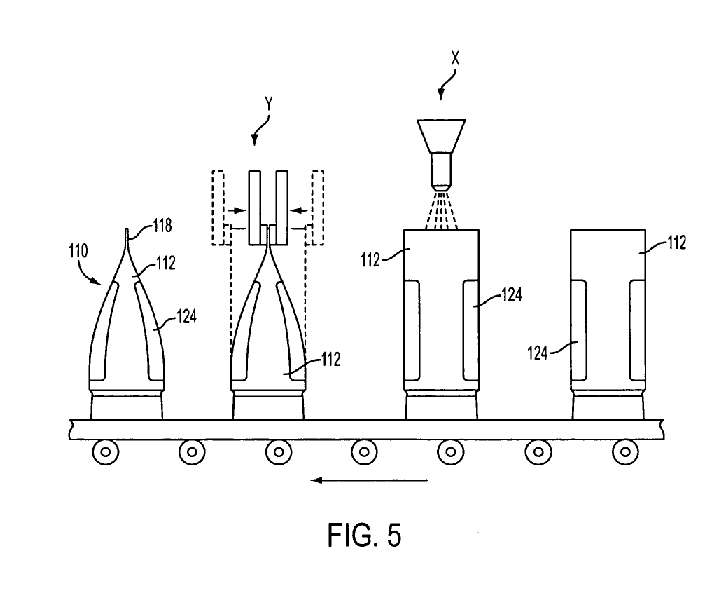

FIG. 5 illustrates an exemplary method of filling the container 110 with products and an exemplary method of creating a seam to close the container 110, according to an exemplary method of creating a filled container 110. After placing the dome of the container 110 from the as formed outwardly projecting position to an inwardly projecting position, an open end of the bottom piece of the container 110 can be filled (e.g., a step X in FIG. 5) with a product and sealed (e.g., a step Y in FIG. 5) with a seam. Alternatively, the container 110 can also be filled while the dome is in an outwardly projecting position.

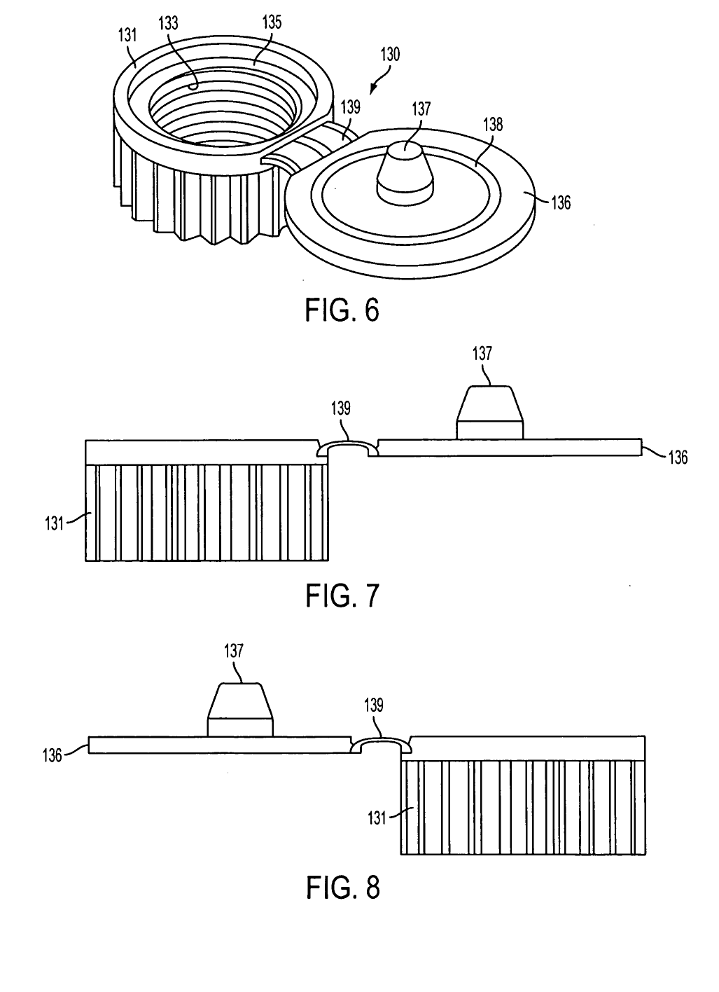

Referring now to FIG. 6, details relating to the low-profile flip-top closure or cap 130 according to a presently preferred embodiment of the invention will now be described. Most pop-up stand-up tubes have an extremely limited amount of space when the dome 126 is inverted as shown, for example, in FIGS. 3 and 4. Other known capping mechanisms (see, e.g., WO0238360 (Cargile et al.) required a twist-off cap or removable threaded cap, which had to be completed removed. As a result, they may be misplaced, dropped, or lost, causing a great deal of inconvenience to the consumer.

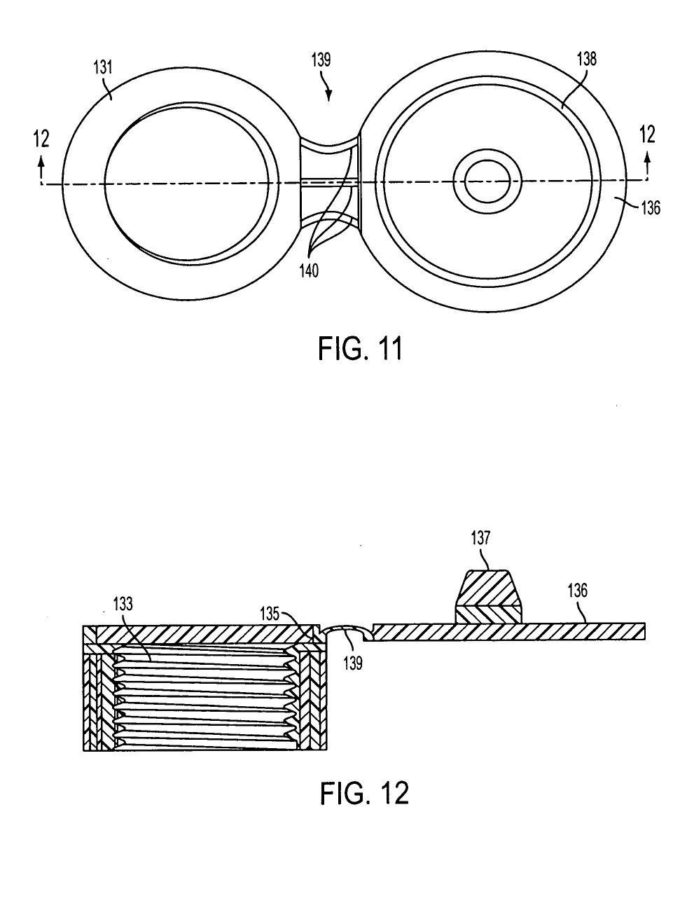

Accordingly, the low-profile flip-top closure or cap 130 according to the present invention is comprised generally of a screw-on/off body portion 131, having a threaded section 133 and an internal seal surface 135, a single wall, extra-thin flip top lid 136, having an external seal plug 137, an internal seal ring 138, and a hinge portion 139, having one or more retention ribs 140 (FIG. 11).

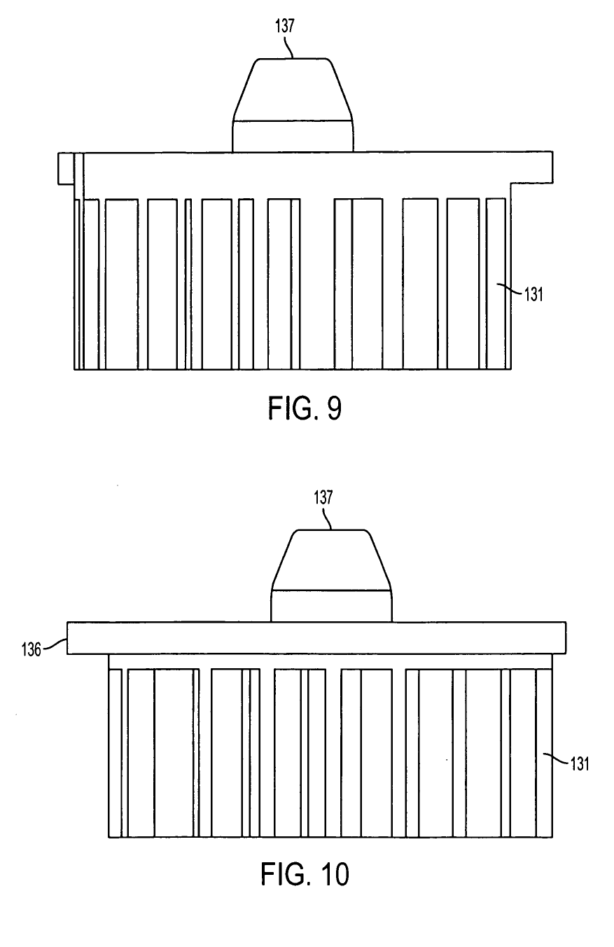

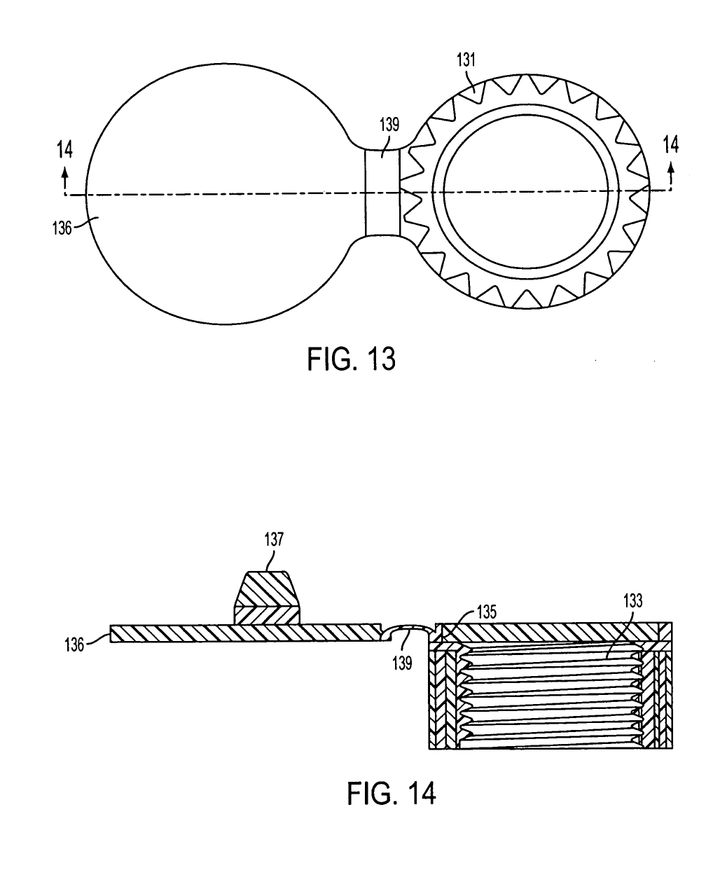

FIGS. 7-14 show various other aspects of the low-profile flip-top closure 130 according to the present invention. The body portion 131 is assembled onto the neck finish 132 of the tube 110 using threaded portion 133. The threaded portion 133 may suitably comprises ¼-20 threads, although any other suitable threads which would correspond to the neck finish 132 can be substituted. The hinge portion 139 allows the lid 136 to move from the open position as shown in FIGS. 6-14 to a closed position as shown in FIGS. 1 and 2. The retention ribs 140 (preferably three as shown in FIG. 11) help secure the lid 136 in the open position. In the closed position, the internal seal ring 138 helps secure the lid 136 to the body portion 131 using the internal sealing surface 135, while at the same time, the external seal plug 137 seals the dispensing orifice at the neck finish 132 of the tube 110.

Thus, the container 110 provides a unique package particularly useful as a single serve food or drink package, or a package for cosmetic or other products, including juices, other beverages, yogurt, sauces, pudding, lotions, soaps in liquid or gel form, and bead shaped objects such as candy. The container 110 can be protected from contamination and unrecognizable tampering prior to use by a purchasing consumer. The container 110 can provide a retractable dome structure that permits the container 110 to be stood upright on the standing ring.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A pop-up, stand-up tube, comprising:
a top piece having:
a tubular sidewall formed from a first material;
a dome covering one end of the tubular side wall of the top piece; and
a hinged interconnection formed between the dome and the tubular sidewall of the top piece;
a bottom piece having:
a tubular sidewall formed from a second material;
a joining region formed between the top piece and the bottom piece for joining the top piece to the bottom piece; and
a low profile, flip-top cap.

2. The pop-up, stand-up tube according to claim 1, wherein the top piece further comprises a neck finish formed on the dome, the neck finish having an opening and male threads.

3. The pop-up, stand-up tube according to claim 2, wherein said low-profile, flip-top cap comprises a body portion having female threads adapted for twist-closure with the neck finish, a lid, and a hinge coupling said lid to said body portion.

4. The pop-up, stand-up tube according to claim 3, wherein said low-profile, flip-top cap further comprises:
an internal seal surface on said body portion;
an external seal plug on said lid adapted for closing the opening in said neck finish; and
an internal seal ring on said lid adapted for engaging said internal seal surface of said body portion when said lid is in a closed position.

5. The pop-up, stand-up tube according to claim 1, wherein the second material is different from the first material.

6. The pop-up, stand-up tube according to claim 5, wherein the second material has a different color than the first material.

7. The pop-up, stand-up tube according to claim 1, wherein the second material is the same material as the first material.

8. The pop-up, stand-up tube according to claim 1, wherein the joining region is a welded region.

9. The pop-up, stand-up tube according to claim 1, wherein the bottom piece further comprises a sealed seam to form a sealed end of the tubular side wall of the bottom piece.

10. The pop-up, stand-up tube according to claim 1, wherein the bottom piece is filled with a product and the top piece further comprises a neck finish having an opening for dispensing the product.

11. The pop-up, stand-up tube according to claim 1, wherein the top piece comprises a standing ring formed between the hinged interconnection and the tubular side wall of the top piece, the arrangement is capable of standing-up on the standing ring when the dome is in an inwardly projecting position so that the dome is below a cross sectional plane of the standing ring.
